(19) United States
(12) Patent Application Publication
(10) Pub. No.: US 2004/0141834 A1
(43) Pub. Date: Jul. 22, 2004

(54) Walk-through container and method for transporting cargo in a trailer of a truck

(76) Inventor: William O. Gohlke, Wellington, FL (US)

Correspondence Address: MANELLI DENISON & SELTER, 2000 M STREET NW SUITE 700, WASHINGTON, DC, 20036-3307, US

(21) Appl. No.: 10/347,334

(22) Filed: Jan. 21, 2003

(51) Int. Cl. B65G 63/00

(52) U.S. Cl. 414/800

(57) ABSTRACT

A method of transporting tires using containers is provided. Each container has bottom flooring, opposing sides, and substantially open front and rear ends such that a user can walk through the container via the open front and rear ends. Each container is constructed and arranged to be transported within an interior of a trailer of a vehicle. The method includes moving a first container to a tire collection location, loading tires into the first container, moving the loaded first container to the trailer and loading the first container into the interior of the trailer, moving a second container to the tire collection location, loading tires into the second container, moving the loaded second container to the trailer and loading the second container into the interior of the trailer so that an end of the second container is generally adjacent to an end of the first container, transporting the trailer with the containers therein to a destination, removing the tires from the second container, and walking through the second container to unload the tires from the first container.

### FIELD OF THE INVENTION

The invention relates to a method of shipping cargo, more particularly, to the use of walk-through containers for transporting tires within a trailer of a vehicle.

### BACKGROUND OF THE INVENTION

Transporting vehicle tires to tire dealers is time consuming and expensive. For example, tires are typically collected by hand from a warehouse and rolled into a trailer of a truck by three or more workers. The tires are then stacked, nested or arranged in other manners to maximize the number of tires received within the interior of the trailer. After being transported to a tire dealer, the tires are removed manually from the truck typically with more than one person.

Accordingly, there is a need to provide a method for shipping tires using walk-through containers sized to be received in a truck trailer so that only one person is required to load, transport, and unload the tires.

### SUMMARY OF THE INVENTION

An object of the invention is to fulfill the need referred to above. In accordance with the principles of the present invention, this objective is achieved by providing a method of transporting tires using containers. Each container has bottom flooring, opposing sides, and substantially open front and rear ends such that a user can walk through the container via the open front and rear ends. Each container is constructed and arranged to be transported within an interior of a trailer of a vehicle. The method includes moving a first container to a tire collection location, loading tires into the first container, loading the first container into the interior of the trailer, moving a second container to the tire collection location, loading tires into the second container, loading the second container into the interior of the trailer so that an end of the second container is generally adjacent to an end of the first container, transporting the trailer with the containers therein to a destination, removing the tires from the second container, and walking through the second container to unload the tires from the first container.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a perspective view of a container for transporting tires provided in accordance with the principles of the present invention.

FIG. 2 is a flow chart describing a method of transporting tires in accordance with the invention.

FIG. 3 is a view of a container of the invention shown loaded into a trailer of a vehicle.

### DETAILED DESCRIPTION OF THE PREFERRED EMBODIMENT

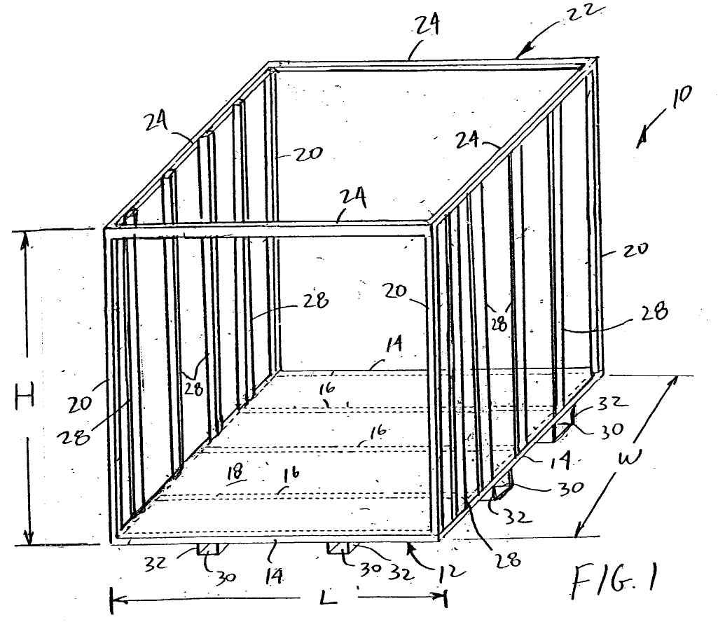

With reference to FIG. 1, a preferred embodiment of a cargo container is shown generally indicated at 10. The container 10 is box-shaped defined by a frame structure. More particularly, a bottom frame, generally indicated at 12, is formed by four bottom members 14 joined to form a rectangular shape. Floor supports are provided in spaced relation to add support to the bottom frame 12. Flooring 18 is provided on members 14 and 16 to define a bottom floor of the container 10. In the illustrated embodiment, the flooring 18 is preferably 18 gage cold rolled steel. The flooring 18 can be of other suitable materials and need not be a solid material. For example, a mesh-like flooring can be used to reduce weight of the container.

Four post members 20 extend upwardly from each corner of the bottom frame 12. A top frame, generally indicated at 22, is supported by the post members 20 and is formed by four top members 24 joined to form a rectangular shape. The members 14, 16, 20 and 24 are preferably 2×2, 3/16 inch square tubes. Side support members 28 are provided at each side of the container 10, extending vertically between the top frame and bottom frame. In the illustrated embodiment, four evenly spaced side support members 28 are provided. The side support members 28 add rigidity to the container 10 and help to maintain cargo within the container 10. Instead of providing four side support members 28, a centrally located support member can be provided and an expanded metal mesh can be welded to the centrally located support member and to the post members 20 to close the sides of the container 10. It can be appreciated that the sides of the container 10 can be configured in any manner that provides rigidity to the container and maintains cargo within the container 10.

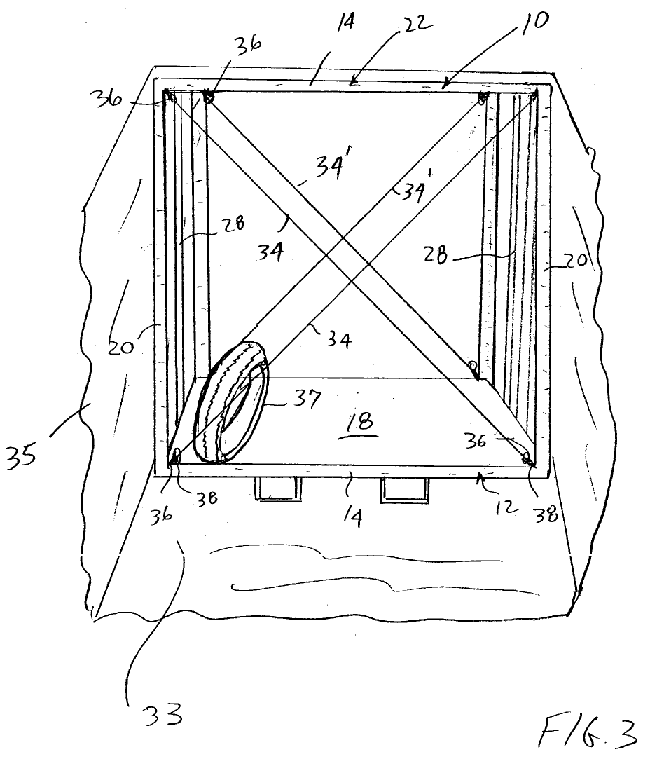

The front and rear ends of the container are open, permitting a user to easily walk into and through containers to load and unload cargo such as tires, as will be explained more fully below. It has been determined that once the tires are stacked or nested within the container 10, the tires stay in place within the container even though the front and rear ends are open. If desired, however, to ensure that the tires do not fall out from the container at the front and rear ends, cargo-retaining structure can be provided. In the embodiment of FIG. 3, the cargo retaining structure is preferably in the form of wire cables 34 each fixed to an eyebolt 36 at upper corner of the top frame 22 and extending diagonally to removably engage with an eyebolt at the bottom frame l2. The wire cables at the rear end are designated as items 34′ for clarity. A releasable connector 38, such as a spring snap 38 (for example, as disclosed in U.S. Pat. No. 1,228,513) is provided at an end of each wire cable 34, 34′ so as to removably engage the eyebolt 36 at the corners of the bottom frame 12. Thus, the pair of wire cables 34 form an X shape at the front end of container 10 and the pair of wire cables 34′ form an X shape at the rear end of the container 10. Straps, ropes, or other retaining structure, sufficient to maintain the tires within the container 10, could be employed as the cargo retaining structure.

In the broadest aspect of the invention, the container 10 includes a floor, two opposing sides, and front and rear ends, with the front and rear ends being substantially open to permit a person to walk through the container.

The bottom frame 12 includes fork-receiving structure defining a pair of slots 30 constructed and arranged to receive forks of a conventional forklift at the front, rear, or either side of the container 10. In the embodiment, each fork-receiving structure includes a pair of generally U-shaped members 32 coupled to and extending from the bottom of members 14 and 16. The U-shaped members 32 are in spaced relation. Preferably, the U-shaped members 32 extend the entire width W and length L of the container so as to be accessed from the front, rear, or either side of the container 10.

In the illustrated embodiment, both the length L and height H of the container 10 is about 96 inches, while the width of W is about 70 inches. With this sizing, the container 10 can fit within an interior 33 of a conventional trailer 35 (FIG. 3) of a semi-truck. Eight containers can fit within a conventional 48-foot trailer so as to consume generally the entire volume of the trailer to maximize the number of tires to be transported.

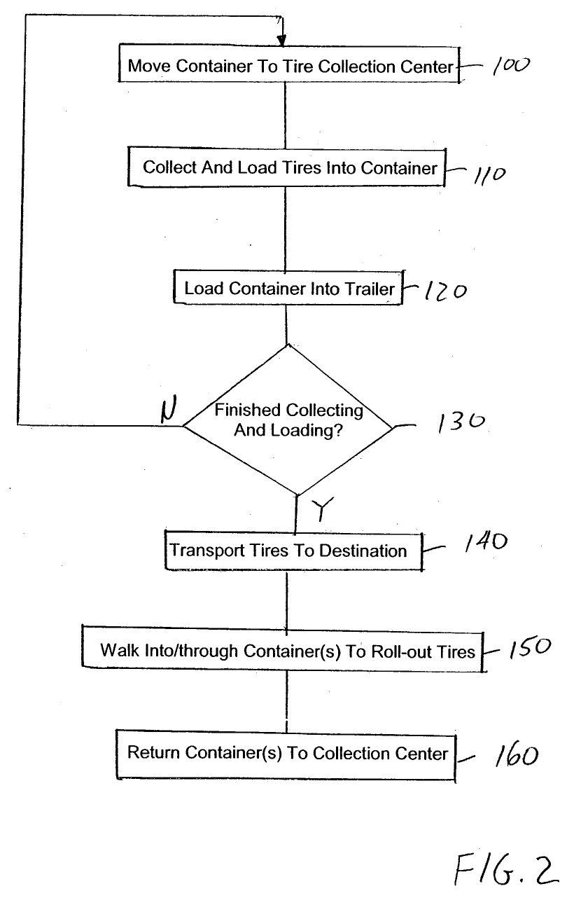

The use of the container 10 for transporting tires is explained below with reference to FIG. 2.

In step 100, a user uses a forklift to move the container 10 to a tire collection location such as a tire warehouse. In step 110, the user collects tires from the warehouse and loads the desired tires 37 (FIG. 3) into the container 10 by walking into one of the open ends of the container 10. Typically, 130 or so tires can fit within the container 10 by nesting the tires the conventional manner. In step 120, the container is then moved and loaded into the trailer 35 of a truck. In step 130, the user determines if more tires are to be transported and if so, the process returns to step 100 and another container 10 is loaded and placed into the trailer so that an end of the previously loaded container is adjacent to or abutting an end of the container being currently loaded. Once no more tries are to be collected and loaded into containers and placed into the trailer, in step 140, the user drives the truck to transport the tires to the delivery destination. At the delivery destination, in step 150, the user walks into the last loaded container and rolls-out the tires from the container floor.

Since the front and rear of each container 10 are open and have no doors, if a number of containers are loaded with ends thereof being adjacent within a trailer, the last-loaded container can be emptied first, and then the user can walk through this container to unload the next, adjacent container and so on. Finally, in step 160, the user can return the empty container(s) to the collection center or take them to a different collection center.

With this method, advantageously only one person is needed for the entire tire loading, transporting and unloading process. Thus, a significant cost savings per each loaded trailer is achieved. Accuracy of tires being delivered is also increased since tires of a particular type can be loaded into a single container, thus, there is less likelihood that tires can be mixed-up within the trailer.

Instead of removing the tires from the containers 10 while the containers are still within the interior of the trailer, it can be appreciated that a container can be removed from the trailer (with tires therein) and transported to a place, such as a warehouse, where the tires can be removed from the container 10.

Although the invention has been described for transporting tires, it can be appreciated that any cargo that can fit inside the container can be transported within the walk through container(s).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of transporting cargo using containers, the containers each having bottom flooring, opposing sides, and substantially open front and rear ends such that a user can walk through the container via the open front and rear ends, each container being constructed and arranged to be transported within an interior of a trailer of a vehicle, method including the steps of:
moving a first container to a cargo collection location,
loading cargo into the first container,
moving the loaded first container to the trailer and loading the first container into the interior of the trailer,
moving a second container to the cargo collection location,
loading cargo into the second container,
moving the loaded second container to the trailer and loading the second container into the interior of the trailer so that an end of the second container is generally adjacent to an end of the first container,
transporting the trailer with the containers therein to a destination,
removing the cargo from the second container, and
walking through the second container to unload the cargo from the first container.

2. The method of claim 1, further comprising:
returning the trailer with empty containers therein to the cargo collection location.

3. The method of claim 1, wherein the cargo is a plurality of tires, and the step of loading the cargo includes nesting the tires.

4. The method of claim 1, wherein the steps of moving the containers and loading the containers into the trailer includes using a forklift.

5. The method of claim 1, wherein each container has a height of about 96 inches, a width of about 70 inches and a length of about 96 inches, and the trailer is a 48 foot trailer, the method further including loading six additional containers into the trailer so that the containers substantially consume the entire volume of the trailer.

6. A method of transporting tires using containers, each container has a bottom flooring, opposing sides, and substantially open front and rear ends such that a user can walk through the container via the open front and rear ends, each container being constructed and arranged to be transported within an interior of a trailer of a vehicle, the method including the steps of:
moving a first container to a tire collection location,
loading tires into the first container,
loading the first container into the interior of the trailer,
moving a second container to the tire collection location,
loading tires into the second container,
loading the second container into the interior of the trailer so that an end of the second container is generally adjacent to an end of the first container,
transporting the trailer with the containers therein to a destination,
removing the tires from the second container, and
walking through the second container to unload the tires from the first container.

7. The method of claim 6, further comprising:
returning the trailer with empty containers therein to the cargo collection location.

8. The method of claim 6, wherein the steps of moving the containers and loading the containers into the trailer includes using a forklift.

9. The method of claim 6, wherein each container has a height of about 96 inches, a width of about 70 inches and a length of about 96 inches, and the trailer is a 48 foot trailer, the method further including loading six additional containers having tires therein into the trailer so that the containers substantially consume the entire volume of the trailer.
